(19) United States
(12) Patent Application Publication
(10) Pub. No.: US 2009/0226152 A1
(43) Pub. Date: Sep. 10, 2009

(54) METHOD FOR MEDIA PLAYBACK OPTIMIZATION

(76) Inventor: Brett E. Hanes, Lula, GA (US)

Correspondence Address: GRAY ROBINSON, P.A., P.O. Box 2328, FT. LAUDERDALE, FL, 33303-9998, US

(21) Appl. No.: 12/401,410

(22) Filed: Mar. 10, 2009

Related U.S. Application Data
(60) Provisional application No. 61/068,718, filed on Mar. 10, 2008.

(51) Int. Cl. H04N 7/26

(52) U.S. Cl. 386/109; 386/124; 386/E05.001

(57) ABSTRACT

A method for maximizing the fidelity of original media files on playback systems of different capabilities comprises conducting an analysis of an original media file to obtain performance-related audio and/or video data that is encoded as metadata and synchronized with the original media file to create an enhanced media file in which the metadata is streamed in advance of the original media file. The enhanced media file in input to a playback controller which employs audio and/or video processing techniques, made possible by receipt of the metadata content prior to the original media file, to optimize the performance of a playback system in a predictive manner for greatly improved performance.

### RELATED APPLICATIONS

This application claims priority under 35 U.S.C. § 119(e) to U.S. Provisional Application Ser. No. 61/068,718 filed Mar. 10, 2008 for all commonly disclosed subject matter. U.S. Provisional Application Ser. No. 61/068,718 is expressly incorporated herein by reference in its entirety to form a part of the present disclosure.

### FIELD OF THE INVENTION

This invention relates to method for media playback optimization, and, more particularly, to a method for maximizing the fidelity of audio, video or multimedia data files on playback systems of varying capabilities.

### BACKGROUND OF THE INVENTION

Consumers experience media, including audio and multimedia, on a wide variety of playback systems, e.g. combinations of components such as video monitors, loudspeakers, amplifiers etc. for viewing and listening to different media. Multimedia contained on digital versatile discs (DVDs), or received from broadcast television, may be viewed on televisions ranging from nineteen inch tube sets to ten-foot wide front-projection systems. Similarly, audio systems range in performance from low cost home theaters to discrete component playback systems using state-of-the-art equipment that may cost tens of thousands of dollars. Movie studios, record companies and sources have the daunting task of trying to create media that is appropriate for playback on such a wide range of systems.

Audio and video processing technologies affect the quality of audio and video reproduction. Current audio and video processing technologies, while quite sophisticated, are saddled with the burden of real-time implementation. These processors have no indication of the content of streamed audio or video signals before they are presented for playback, which places serious limitations on how their functions can be executed. Real-time processors must be fast, and they can only analyze data for a very short time before it must be altered and released.

Additionally, inherent performance limitations in each of the components of playback systems have an effect on the creation of media meant for such systems. In general, audio processing for inexpensive systems should be very different than that required for the dedicated enthusiast's system, both in terms of performance and to protect system components from damage. Audio compressor (limiting) circuits, for example, are used to prevent damage to speaker and amplifier components, such as discussed above, and/or to mask the performance limitations of these components during use. These devices must be set up with an attack time, release time, compression ratio, and compression characteristic during the design phase. Engineers choose these parameters on the basis of the desired audible playback result. As such, these components are typically created as “general use” devices meant to perform adequately in a variety of situations. But such general implementation results in sonic compromises. Typical parameters for a bass-region limiter are quite different than those for a midrange or treble limiter. Consequently, the consumer must purchase multiple products to optimize a system or be satisfied with compromised performance.

Video processing is an excellent example of truly burdensome real-time processing. Video streams, especially in “high definition” as discussed above, convey massive amounts of data. Activities like deinterlacing (interlaced to progressive conversion), resolution conversion (for a fixed-pixel monitor), 3:2 pulldown (conversion from film to video format), motion compensation, and brightness enhancement (iris or backlight manipulation to improve black levels) require very fast, powerful and expensive microprocessors and intelligent algorithms. In view of the wide variety of video monitors used by consumers, it is very difficult to optimize video content to view well on such a range of monitor systems. It is also quite expensive to include the video processing technology necessary to manipulate the video stream in real-time in a performance appropriate manner.

### SUMMARY OF THE INVENTION

This invention is directed to a method for maximizing the fidelity of original media files on playback systems of different capabilities.

This invention is predicated on the concept of conducting an analysis of audio, video or multimedia files to obtain performance-related audio and/or video data that is encoded as metadata which is streamed to a playback controller in advance, or prior in time, to the original media file. The playback controller, using a number of audio and/or video processing techniques, takes advantage of its “prior knowledge” of what the original media file will do next, based on the content of the metadata, and is effective to optimize the performance of the components of the playback system in a predictive manner for greatly improved performance.

The analysis of the original media file may be conducted on an analyzer engine located at the site of the playback system, e.g. within one's home for example, or can be implemented by the studios, recording companies or other originators of audio, video and multimedia files. The analysis results in the identification of a number of performance parameters such as total audio bandwidth, audio crest factor, maximum audio signal level, frequencies of maximum audio level, time duration of peak audio signals, maximum video brightness, minimum video brightness and others. The analyzer engine is operative to synchronize the metadata with the original media file to create an enhanced media file in which the metadata is streamed to the playback controller “ahead of” or prior in time to the original media file.

The enhanced media file is input to a playback controller coupled to a playback system. Using various audio and video processing techniques, discussed below, the playback controller functions to optimize playback performance while protecting components of the playback system from damage. For example, the playback controller may ensure that the audio component(s) of the playback system present material as loudly as possible with minimal risk of damage to the components. Audible bandwidth can be maximized, e.g. maximum bass, with little danger of harming any one of the components. Compression and limiting may be applied to all channels of the audio components individually in the most helpful and best sounding manner. Any user equalization settings may be taken into account during playback to ensure that no performance envelopes are violated. An audio channel's bandwidth may be dynamically limited to permit louder sound output with minimal risk of overload. Volume levels of individual channels may be altered to make voice dialog clearer or to better match the dynamic range capabilities of all of the components in the playback system. The playback controller may operate to modulate the backlight of video components of the playback system, based on “prior knowledge” of the content of the original media file provided by the metadata, to maximize brightness and black level. With foreknowledge of the movement between frames of the video data in the original media file, video motion compensation may be executed in ways not possible with conventional playback systems.

The method of this invention may be implemented in a number of different embodiments. As noted above, the analyzer engine may be incorporated in an overall system at a residence or the like to produce an enhanced media file that may be stored on the playback controller of the system, or, alternatively, this function may be performed by the movie studio, recording company or other originator of media and provided to the consumer in the form of a DVD, CD or the file that already contains an enhanced media file.

In another embodiment of this invention, it is contemplated that an analyzer engine may be employed with broadcast media, e.g. audio or multimedia files that are produced by a television network or broadcast by cable or satellite providers and received on a broadcast receiver, such as a cable box, located in the home or other location. A playback controller coupled to the broadcast receiver and to the playback system may perform the same audio and/or video processing techniques noted above to improve the fidelity and overall quality of the media presentation.

In a further embodiment, classic media files such as older movies may also benefit from the method of this invention. Their content may be analyzed by the techniques noted above, and discussed in more detail below, to produce an enhanced media file for input to a playback controller with the original, classic media file.

Another aspect of this invention optionally involves the prior testing of components of the playback system. For example, performance specifications of video monitors, loudspeakers, amplifiers and other components of the playback system may be tested by their manufacturers or others and assigned qualification designations. These qualification designations may be input manually or automatically to the playback controller so that the performance capabilities of the playback system may be taken into account by the playback controller as it executes audio and video processing techniques. Consumer playback options may also be accepted by the playback controller, such as different forms of equalization.

The method of this invention is intended for use with playback systems of all types. Regardless of the level of sophistication of the playback system, but particularly for somewhat less expensive applications, greatly enhanced media presentation will be achieved. Additionally, since audio processing is level dependent, i.e. affected by the volume level set by the user, the method of this invention is particularly useful for improvement of the audio fidelity of media files.

### BRIEF DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is schematic, block diagram view of one embodiment of the method of this invention;

FIG. 2 is a schematic, block diagram view of one embodiment of the method of this invention for producing an enhanced main data or media file;

FIG. 3 is schematic, block diagram of a method for playback of the enhanced main data file produced in FIG. 2;

FIG. 4 is a schematic, block diagram view of another embodiment of the method of this invention for use in applications employing classic main data files such as old movies; and

FIG. 5 is a schematic, block diagram view of a still further embodiment of the method of this invention for use in broadcast media applications.

### DETAILED DESCRIPTION OF THE INVENTION

Referring now to the FIGS., the method of playback optimization according to this invention is described with reference to several embodiments. For purposes of the present discussion, it is assumed that the media to be optimized is a multimedia file, such as a DVD, containing both audio data and video data. It should be understood, however, that this invention is equally applicable to a media file containing only audio data, such as a compact disc (CD), or only video data.

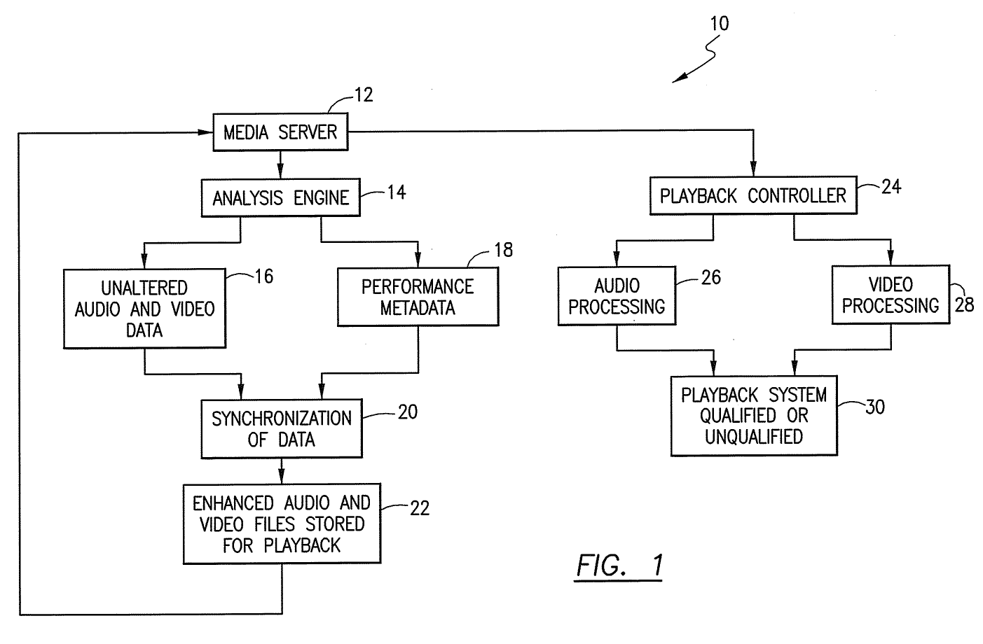

The apparatus 10 illustrated in FIG. 1 depicts an embodiment of this invention that may be employed in one's home, for example, or at another location having a playback system. As noted above, the term “playback system” collectively refers to components capable of reproducing audio media, video media or multimedia, such as loudspeakers, amplifiers, video monitors and the like. A media server 12 is coupled to an analysis engine 14, which may be integral with or separate from the media server 12. The analysis engine 14 may comprise software running on a personal computer, a workstation or a server, with or without add-in hardware cards. Alternatively, the analysis engine 14 may exist as a stand-alone device utilizing onboard digital signal processing (DSP) and microprocessor hardware with appropriate software, or be integrated into a home theatre receiver that contains onboard or removable storage means such as a plug-in USB drive or a hard disc.

The original media file contained on a DVD is input from the media server 12 to the analysis engine 14 which is operative to generate performance parameters of the audio data and video data contained in such file. The performance parameters are encoded in the form of metadata. The metadata may contain both “global” and “local” parameters that are used by the apparatus 10 to enhance playback, as discussed below. Global parameters may include general information about the original media file that may be used to set the overall performance envelope for the playback system. Assuming the DVD contains a movie, for example, the global parameters may include an identification of the type of movie, e.g. action movie, drama, documentary etc. Other global parameters of the original media file contained in the metadata may include total audio bandwidth, audio crest factor, maximum audio signal level, frequencies of maximum audio level, time duration of peak audio signals, maximum video brightness, minimum video brightness, audio and video dynamic range and any other parameter that includes performance-related data which is considered useful for initial settings of the playback equipment.

Continuous or “local” parameters identified by the analysis engine 14 and encoded as metadata consist of performance data similar to that of the global parameters but on a more time-localized basis. Time duration, crest factor and bandwidth data are particularly important on the local timescale.

It is contemplated that the analysis that results in the identification of the global parameters and local parameters may be executed by the analysis engine 14 at times when the consumer is not present or otherwise not using the playback system, e.g. when at work or overnight while sleeping.

In the schematic depiction of the apparatus 10 of this invention shown in FIG. 1, the analysis engine 14 is illustrated as outputting a stream of unaltered audio and video data, e.g. the original media file, represented by box 16, and, a stream of the performance metadata represented by box 18. These data streams are synchronized by the analysis engine 14 as represented by box 20 to create an enhanced audio and video file, or an enhanced media file, represented by box 22. The enhanced media file is shown as being input to the media server 12 for storage and playback. It is contemplated that the enhanced media file may be stored in the memory of the media server 12 or externally on a small thumb drive, for example.

An important aspect of this invention resides in the synchronization of the original or unaltered audio and video data stream with the metadata stream. In the presently preferred embodiment, the metadata is streamed from the enhanced media file in advance of or prior in time to the corresponding audio and video data contained in the original media file. As discussed in detail below, as a result of being provided with an indication by the metadata stream of the character of the audio and video signals from the original media file before they are actually received, the playback controller 24 of this invention is effective to execute audio and video processing to optimize playback of the original media file.

The enhanced media file is input from the media server 12 to the playback controller 24. In the presently preferred embodiment, the playback controller 24 may comprise a stand-alone unit with appropriate software or DSP and microprocessor code. Specifically, the playback controller 24 may be computer software (and potentially hardware) running on a media server computer, or, embedded as a built-in processing function in a home theatre receiver, preamplifier and video monitor device.

The playback controller 24 is effective to execute audio processing represented by box 26 and video processing represented by box 28 of the enhanced media file prior to output to the playback system 30. In general terms, the function of the playback controller 24 is to receive the local parameters contained in the metadata of the enhanced media file which precedes the original audio data and video data by a set amount of time. The playback controller 24 buffers this information and uses the included time code to apply the local parameters to the relevant playback processors when appropriate. The local parameters within the metadata stream may be used on a real-time basis, e.g. constantly updating and adapting the playback processors. Alternatively, the local parameters may apply to sections of a movie, music blocks, particular songs or entire chapters of material, in which case the playback controller 24 may apply such local parameters for that particular block of time and then load the next set of local parameters. Processing algorithms in the playback controller 24 for the local parameters ensure a seamless media experience with no obvious indication that adaptations are occurring. With intelligent control algorithms, the playback controller 24 can use local parameters to anticipate needed settings of the playback system in relation to what came before a certain event and what will come after such event.

Additional data may be input to the playback controller 24 to enhance optimization of the original media file. In one presently preferred embodiment, the components of the playback system 30 may be “qualified” as denoted in box 30. Manufacturers of playback system components, or other testing entities, may perform acoustic and video tests to establish qualification designations for such components. Loudspeakers, for example, may be subjected to tests including baseline sensitivity, low-power frequency response, maximum output sound pressure level or SPL, voltage input at max SPL, usable bandwidth at maximum SPL, swept input power frequency response measurement to determine the dynamic envelope performance, total harmonic distortion or THD, multitone distortion and others. Characterization tests for audio electronic components may include maximum power output, input sensitivity for 1 watt power output, input sensitivity for maximum power output, allowable speaker impedance range and other tests. Video system characterization tests may include maximum light output, standardized contrast ratio, color parameters, native resolution, refresh rate and others. It is contemplated that the qualification designations of the playback system 30 may be input to the playback controller 24 manually, or such designation could be input to the playback controller 24 automatically from the various components of the playback system 30 at the time of setup. In either case, the playback controller 24 is effective to make allowances for the varying capabilities of different playback systems 30 and adjust the audio and video streams from the enhanced media file accordingly. Notwithstanding the foregoing discussion, it should be understood that the playback system 30 need not be qualified in order for the playback controller 24 to operate effectively.

The playback controller 24 may also accept consumer playback options. For example, many different forms of equalization may optionally be input to the playback controller 24 such as a “midnight” mode to limit late-night output SPL, a “dialog” mode to maximize speech articulation and audibility and an “enhanced low frequency” mode that would boost bass and/or add low frequency harmonics to enhance the media presentation. In every instance of data input to the playback controller 24, it is effective to prevent overdrive or other damage to the playback system 30 while allowing maximum performance up to the limits of a particular system even in the event of inappropriate user equalization.

A number of different techniques for audio processing (box 26) and video processing (box 28) of the enhanced media file may be performed by the playback controller 24. An overall discussion of different audio and video components of the playback system 30 is provided below, including various audio and video processing techniques that may be executed by the playback controller 24.

### Audio Components and Audio Processing Techniques

With respect to audio components of a playback system 30, loudspeakers of a specific size are normally suited to a particularly sized room in order to achieve a certain loudness level. Loosely stated, larger speakers will play louder than smaller ones. Small speakers in a small room typically pose few problems, but small speakers in a large room can easily be overdriven just to get a reasonable volume level at the listening seat.

Any speaker, no matter how large, will only play so loud without distortion, e.g. the production of added sound components not related to the source signal. This is true for the small speakers in a television and for the large six feet tall tower speakers that may be employed in a dedicated home theater. When any speaker is pushed beyond its maximum clean volume, distortion products of various types are introduced because components of the speaker system begin to function in an unintended manner.

Loudspeakers themselves are deceivingly complex electromechanical devices. They use a permanent magnet and a coil of wire to change electrical signals into mechanical motion that results in audible sound waves. When a loudspeaker is operated beyond its loudness limits, several undesirable things can happen, either separately or all at once. Speakers create sound by movement of their cones, domes, or diaphragms. When a loudspeaker is played too loudly, the cones may move too far. For a given loudness, a small speaker cone has to move a greater distance than a larger one. This extreme motion results in distortion that can have two causes, e.g. either the magnetic field provided by the speaker's motor system becomes non-ideal causing the cone to move irregularly, or, the diaphragm itself is physically stressed by the motion causing it to bend, resonate, or ring in an undesirable fashion. Both of these events will cause the loudspeaker to sound very differently than it did at moderate volumes, usually in an unpleasant way.

Besides causing distortion, excessive cone motion can lead to outright physical damage. The mechanical parts of a loudspeaker driver are made to move only so far. Operating a loudspeaker beyond its design limits can result in parts literally crashing together. When parts contact each other, strange clicking and clacking sounds are heard from the loudspeaker. Eventually this “over excursion” of the loudspeaker cone will result in speaker failure.

In order to obtain large cone motions and, therefore, high volume levels, loudspeakers receive powerful signals from an audio amplifier. The amplifier takes the small signals coming from a DVD or cable box and makes them big enough and powerful enough to create large cone motions. The louder a loudspeaker plays the more power it requires from the amplifier. Since loudspeakers are not typically very efficient, waste heat builds up within the loudspeaker over time. If the loudspeaker gets too hot, such as by playing it too loudly for a long period of time, it will fail due to some internal part melting or falling apart.

However, loudspeakers generally sound better when paired with larger, more powerful amplifiers. With higher power available, e.g. a higher watt rating, the loudspeaker will reproduce transients or fast sounds such as snare drum strikes with more punch and snap. The loudspeaker will usually sound “quicker” with more visceral impact and a greater sense of rhythm. All of these traits are desirable, but the loudspeaker cannot be overpowered by the amplifier by applying to much power over too long of a time period without risking failure as discussed above.

Low frequencies such as explosions, bass drums or bass guitars in the soundtrack of a movie require more cone motion for a given loudness than higher frequencies, e.g. snare drums, guitars, voices, or cymbals. As a result, a loudspeaker with a wider frequency range or bandwidth often cannot play as loud without potential damage. Because of this physical fact, a loudspeaker may be allowed to play louder without risk of damage by restricting its bandwidth, e.g. “cutting off” or filtering out low frequencies. This may result in not getting the deepest notes from a pipe organ or a movie explosion, but it will allow the higher frequencies to get louder since the low frequency movement burden has been removed. The absence of some frequencies is usually better tolerated by the listener, rather than risking distortion from overdriving the speaker. In some situations, this may be a very desirable tradeoff.

When playing a loudspeaker at a very loud level, significant power is drawn from the amplifier. If the volume is turned up too high, the amplifier attempts to operate beyond its power limits and “clipping” occurs. Sound waves can be envisioned mathematically as smoothly rounded sine waves. As the sound output gets louder, the sine waves driving the speaker get larger and larger. The voltage rails of the amplifier act as a “window” for these sine waves. As long as the output is low enough, the tops of the sine waves do not touch the top and bottom edges of the window. However, if an amplifier is driven too hard, the tops and bottoms of the sine waves “run into” the window edges and their smoothly rounded tops and bottoms are flattened out. This is known as “clipping”. When clipping occurs, high frequency sounds begin to sound harsh or brittle and low frequency sounds such as an explosion in a movie may sound “loose”. In extreme cases, where the amplifier is operated well beyond its design limits, the audio output of the system may be such that it seems one or more of the loudspeakers has failed. There is also the possibility of damaging the amplifier due to excess heat buildup when the system is played at clipping levels for long periods of time. Since louder sound requires more power, smaller amplifiers with a lower wattage rating are more susceptible to clipping distortion and are more likely to fail from being overdriven. Since smaller amplifiers are often paired with smaller loudspeakers, it is apparent why it is difficult for a television in a large room to fill the space with adequate sound.

Adaptive Equalization and/or Level Control

Equalization (EQ) comprises electronically boosting or cutting sound energy in a particular frequency range. Examples of these frequencies are the bass region (+/−40 Hz—explosions & kick drums), the midrange (+/−900 Hz—voices & brass instruments), and the treble region (+/−8 kHz—cymbals).

Manipulating certain frequencies can have a profound affect on the way audio material sounds. For instance, bass material can be made more punchy and impactful by boosting the 60 Hz to 80 Hz range. Spoken material can be made to stand out by boosting the 500 Hz to 2 kHz range. Finally, cymbals and other high frequency sounds can be accentuated by boosting the frequencies above 4 kHz. On the other hand, there may be occasions wherein it is desirable to cut certain frequencies. For example, if a particular vocal performance is sibilant sounding (rather extreme emphasis on the “s” and “p” sounds) frequencies in that region may be cut to largely remove the problem. If a particular recording is “boomy” or sounds overbearing in the bass. e.g. the bass sounds swamp out other audible information of interest, the region below about 60 Hz may be cut in order to help lower midrange sounds come through with more clarity.

It is also useful to note that the human ear is more or less sensitive to certain frequencies depending on their loudness. At very low levels, bass frequencies have to be significantly louder than vocal frequencies to be perceived as “equally loud”. Likewise, high frequencies also have to be boosted to seem as loud as the critical 1 kHz voice range. As the overall sound level gets higher, our perception of various frequencies begins to “even out”, meaning that bass and treble sounds begin to sound equally loud as the midrange for the same physical loudness measure. Equalization can help to correct this perception difference when listening at low levels by boosting the bass and treble independently of the midrange. The midrange may be boosted, or, alternatively, the bass and treble may be cut, to accentuate the midrange and make vocals easier to hear.

The term “level control” as used herein refers to changing the individual loudness of the particular speakers in a multichannel movie or music system. Typically, playback systems 30 are characterized as including left, center, and right speakers in the front stage, a subwoofer for bass and two or more surround sound speakers usually called left-surround and right-surround (at minimum). Large systems will often add a center-surround.

Normally, equalization and level settings are created as overall system parameters and are permanently set. Levels and EQ are not normally altered during program playback. Once set, they are generally left alone for playback of all media material. This is unfortunate because significant benefits could be obtained by subtly altering these parameters during playback according to certain guidelines. While it would be advantageous to alter EQ and other level settings, the issue in convention playback systems is how should those settings be changed when it is unknown what frequencies are coming up next in the original media file and how loud they are? Will the next scene contain more vocal or machine gun sounds? Can the level of the center channel be raised to make the dialog easier to hear? Will the bass in an upcoming scene overwhelm a modest playback system, or could the subwoofer level be boosted for better low-level listening or enhanced overall excitement? Can the level of the surround speakers be boosted to make the presentation more immersive without taking away from upcoming front-and-center action?

The issues noted above may be addressed with the method of this invention. Since the playback controller 24 has advance notice of both frequency content and relative loudness of the original media file, level and equalization decisions such as those raised by the questions noted above can be intelligently made in advance. Using the global performance parameters obtained from the analyzer engine 14, the overall system levels and EQ settings can be made appropriate to the entire piece of media. Then, the local parameters can be used by the playback controller 24 to smoothly change EQ and level settings as the movie or music plays to achieve the effects that the consumer desires.

A key feature of the method of this invention is its ability to look at a block of data including past and future values. This suddenly takes away the need for a prediction algorithm, used in the prior art, and paves the way for a decision algorithm employed by the playback controller 24. If level and EQ settings are altered in a crude way, the effects can be objectionable and very annoying. Since the playback controller 24 is provided with metadata indicative of performance parameters contained in the original media file before the audio and video signals in the original media file arrive at the playback controller 30, the playback controller 24 may make changes in the smoothest and most sonically benign manner possible, greatly enhancing the audio experience.

Further, if the components of the playback system 30 are qualified, as discussed above, so that the playback controller 24 has “knowledge” of such component's capabilities, the settings above can be applied in such a way that they are never so extreme as to risk system damage or cause excessive distortion.

### Bandwidth Enhancement (or Adaptive Filtering)

Bandwidth Enhancement is a simple extension of the ideas discussed. Another audio processing technique is filtering. Filters work in prescribed frequency range and basically allow only frequencies in a prescribed range to pass while blocking others outside of such range. For example, if a modest system is being played at a given loudness, it may be able to play much lower bass notes without risk of damage as noted above in connection with a discussion of low frequencies vs. speaker cone movement. Since bass adds excitement to most music and movie material by providing its mood-setting background and impactful effects, playing a wider bass range when conditions allow it would be quite desirable. This is where adaptive filtering comes in.

Using an enhanced media file containing metadata identifying performance parameters of the original media file, the playback controller 24 is provided with advance “knowledge” of the bass content and relative loudness of upcoming material. If the playback system 30 is capable of playing back the content without strain, the playback controller 24 can pass a wider range of bass content. On the other hand, if large explosions are coming up in the original media file and the level is too loud for the playback system 30 to handle, the playback controller 30 can adaptively filter or “roll off” this bass material to allow the overall level to be maintained without damaging the playback system 30. Since the playback controller 30 can examine a significant block of past and future material, this filtering can be done in a smooth and unobtrusive manner to enhance the consumer's experience. Importantly, the processing performed by the playback controller 24 exists in the concrete realm of intelligent decision making rather than the foggy continuum of prediction. Further, it is noted that the processing executed by the playback controller 24 may be intimately linked with the playback system's 30 volume control. Consequently, the playback controller 24 can adapt playback conditions seamlessly according to the consumer's desired loudness level.

### Dynamic Range Enhancement

Dynamic range is an expression of the difference between the lowest level sounds and the loudest level sounds in a piece of media. Material with a high dynamic range is generally more exciting because the mood is enhanced by the swing between quiet and loud passages. Low dynamic range material has less overall loudness variation, which can be useful when listening in a noisy environment, or while viewing a movie at a time when it is desired to maintain the overall sound at a low level.

As described above in connection with discussion of loudspeaker capabilities, a given system can potentially play louder if it responsible for less low frequency content. As such, if it is desired to play back a movie on a television at a louder than average level and there is a willingness to compromise somewhat on bass output, this can be done by filtering out the lower frequencies. Such filtering may be accomplished in such a way that it is linked to the consumer's volume control based on the overall characteristics of the movie content, input to the playback controller 24 as a performance parameter. As such, this filtering can be changed on a moment-by-moment basis that is appropriate to the specific audio content. If a television qualified, the playback controller 24 can filter the bass at whatever rate is appropriate to provide the desired average playback level without risking damage to the television's speakers or internal amplifiers.

### Compression and Limiting

Compressors are electronic components which are primarily concerned with the amplitude or level of audio signals. A compressor receives an the incoming audio signal and compares it to a set threshold level. If the signal is below the threshold, the compressor passes the signal without alteration. If the signal is above the threshold, e.g. too loud, for example, the compressor “compresses” or attenuates the signal (lowers its amplitude) until it conforms to the threshold value. The threshold sets a given “window” in which the audio signal is allowed to exist. If the signal tries to move outside the window, the compressor acts very quickly to turn down the signal volume. If the threshold is set too low, a lot of material gets attenuated, lowering the dynamic range or excitement of the material. If the threshold is set too high, signals that are too large will pass through the compressor, potentially damaging downstream components or causing distortion.

Besides the threshold, compressors have a number of other adjustable settings which must be determined during the setup phase. The “attack time” of a compressor determines how quickly it acts to turn down a signal once the threshold is crossed. If attack time is set too slowly, loud signals will pass through the compressor before attenuation begins, potentially resulting in downstream distortion or equipment distress. If attack time is set too fast, desired transients, such as initial kick-drum beats, can be blunted by the attenuation action of the compressor. The “release time” of a compressor determines how long it maintains attenuation after the signal drops back below the threshold. If the release time is too short, audible “pumping” of the compressor may occur with certain material. Pumping takes place when the compressor is attenuating a signal, releases back to full level, and then has to immediately attenuate again. It is especially annoying with action movie material where explosions and other low frequencies of the soundtrack cause a subwoofer to pump in and out of limiting. With almost all compressors, the initial transient that passes over the trigger threshold turns “on” the attenuation and determines the attenuation level. Then the attenuation stays “on” until the release time has passed. Therefore, if the release time is too long, e.g. long after the initial transient is attenuated when it need not be, the dynamic range of the material may be locally lowered.

Some compressors have an adjustable “compression ratio” which allows attenuation to be applied in a specific input/output ratio once the threshold is crossed. Very sophisticated compressors can have a nonlinear “compression profile” that an engineer can set to achieve certain sonic characteristics. Compressors of this type are more common in recording and mastering studios where they are used to artistically sculpt the recorded sound.

A limiter is a special type of compressor which acts very quickly to “clamp” a signal to keep it from exceeding a specified level. Limiters are usually employed when equipment damage or gross distortion would result from signals exceeding a specified amplitude. They tend to have faster attack and release times than standard compressors.

Audio engineers use compressors and limiters to control signal amplitudes. Recording engineers use them to prevent large signals from a microphone from overloading the recording equipment, which can happen in situation such as a vocalist singing very loudly in close proximity to a microphone in a studio. Digital recording systems are especially sensitive to overload since gross distortion will result if a certain amplitude is exceeded—generally referred to in digital systems as Full Scale level or “FS”. Mastering engineers, who are the last audio engineer to work on a piece of media before it goes into CD or DVD production, use compressors and limiters to change the dynamic range of material (turn down the loudest sounds). They can also artfully use compressors to change the character of a piece of music so that is sounds more pleasing to the artists or producers. Amplifier designers use limiters to prevent audible distortion from power amplifier clipping, as discussed above. If the incoming signal exceeds threshold and will cause the connected power amplifier to clip, the limiter will quickly turn down the signal to prevent this from happening. Finally, loudspeaker designers use limiters to turn down signals that might otherwise damage the drivers themselves. Usually, limiting is applied to bass frequencies that would cause woofers or subwoofers to move too far and create distortion or produce damage.

Compressors can be either analog or digital components. Analog electronics are naturally very “fast”. Because of this, analog compressors can very quickly compare the input signal to the threshold value and determining what to do with it. Analog compressors are not predictive components, but they do operate very quickly to execute their function.

Digital compressors are different. Their “speed” of response is determined by the design sample rate, usually given in kilohertz. Because the minimum length of time a digital component can examine is the mathematical inverse of its sample rate, it can only respond so quickly to a given event. Consequently, in order to respond to fast signals, digital compressors either have to store a certain number of samples in memory, thus creating a signal chain processing delay, or their sample rates have to be increased to two or more times the normal rate.

Using a higher sampling rate places greater demands on all the components in the compressor, e.g. faster microprocessors, digital-to-analog converters, etc. must be used, and the physical design of the circuit boards and related parts becomes more critical. Using memory storage to create a form of “look ahead” processing creates a signal throughput delay that may not be tolerable. When audio is delayed relative to any video content that is present, or vice versa, “lip sync” problems can result where the actors' words and the appropriate sounds are out of time. Lip sync issues are particularly annoying to the viewer, and only very high-end equipment has the facilities for correcting this type of distortion.

Whether analog or digital, system settings for compressors and limiters are usually established once and then left alone. A compressor's sonic signature (the sound it produces) is intimately linked to the parameter settings discussed above. Limiters for bass, vocal, and high frequency sounds are quite different, and one type of limiter does not work well doing the job of another.

As is apparent from the discussion above, one of the big challenges with compressors is speed. Digital compressors invariably wind up causing signal delays because they cannot be made to run fast enough in an economical fashion. With the method of this invention, streaming of the performance parameters to the playback controller 24 prior to the original media file permits true “look ahead” processing without having to delay the signal stream. Also, since the playback controller 24 has “knowledge” of what just occurred sonically and what is coming next, its processing capability allows for intelligent decisions about how to alter the compressor's parameters to enhance the audio experience. For instance, when using a subwoofer, the limiter's threshold could be raised depending on the very low frequency content of the signal. If a very large, low frequency signal is coming up, the threshold can be gradually lowered again to prevent speaker damage.

### Video Components and Vidio Processing Techniques

Almost all consumer video material is delivered in an interlaced picture format. Based on the historical analog NTSC standard, video material is recorded at 30 frames per second, but then it is displayed at 60 fields per second “interlaced” in a 4:3 (horizontal to vertical) aspect ratio (screen shape). This is commonly known as “standard definition” television. One “frame” can be thought of the same way as a single frame of motion picture film. The frame is one of the still “pictures” that is flashed rapidly on screen to create the effect of motion. Interlaced displays take advantage of a human's “persistence of vision” where images remain in our perception for a fraction of a second before fading away, much the same way film creates the illusion of motion from a series of still pictures shown at a certain rate. A video field, on the other hand, is one half of one frame. Thus, one frame is made up of two interlaced video fields.

All of this is a holdover from the time when every television was picture tube (CRT) based. In the NTSC system, there are 480 “scan-lines” of visible picture information. An NTSC television displays only one half of the 480 scan lines, either odd or even, and then it displays the other half of the scan lines to create each frame. The odd/even sequence repeats 60 times per second to effectively create the 30 frames per second viewing rate described above. Scan lines are inherently different from digital “pixels” in that they can vary greatly over their entire length based on the analog signal creating them. Pixels, on the other hand, are individually determined and represent only one tiny spec of the picture. For comparison sake, if the NTSC screen resolution was expressed in digital terms, the closest analogy is 640 horizontal pixels by 480 vertical pixels. Standard definition television is usually referred to as “480i” (480 lines interlaced).

Almost all television systems internationally have operated on a system similar to NTSC for decades. Other world television formats are PAL (Europe, Asia, & most of Africa) and SECAM (France, Russia, and approximately one third of Africa). The PAL system uses 576 visible scan lines at a rate of 25 frames (50 fields) per second. SECAM also uses roughly the same number of visible scan lines at a 25 Hz frame rate; however, the encoding for the picture information is different than that of PAL. Having these three major display standards to contend with creates a lot of overhead for studios who produce movie and video content.

New digital broadcast standards have recently been introduced with utterly different specifications. These standards are for what is commonly known as “high definition” television (HDTV). North America has adopted the ATSC standard. Europe, Australia, and Russia use the DVB/T standard. Finally, China uses the DMB-T/H dual broadcast standard. Although their specifics are different, all of these standards work in a manner similar to ATSC. The ATSC standard has a maximum possible resolution of 1920 (horizontal) by 1080 (vertical) pixels in a “progressive scan” or non-interlaced format, where all pixels are refreshed, e.g. redrawn at up to 30 frames per second. This is often expressed as 1080p30 or simply 1080p. The maximum frame rate for ATSC was established by digital transmission limits, which can only allow a certain amount of data to be sent. The most common actual broadcast rate is 1080i30, typically expressed as 1080i, so that more channels can be transmitted in a given bandwidth. ATSC also specifies a screen aspect ratio of 16:9, which is much wider than the old NTSC format. The 16:9 format was chosen because it strikes a reasonable compromise between all of the various programming formats currently used as noted below.

Blu-ray discs can achieve a maximum display resolution of 1080i or 1080p24 for film-based material. Video resolution on optical discs such as DVD and Blu-ray is limited by the amount of data that can be stored on each type of disc for a given amount of playback time. Currently, the maximum HDTV resolution contemplated is 1080p60, e.g. a full progressive image with a refresh rate of 60 frames per second.

All digital displays including liquid crystal display (LCD) computer monitors, LCD televisions, plasma televisions, digital light processing (DLP) televisions, and liquid crystal on silicon (LCOS) televisions have a fixed pixel count (resolution) and screen aspect ratio. This is called the “native” resolution of the display. All digital displays are capable of refreshing or redrawing their screens at a certain rate, usually 60 Hz, with the latest LCD televisions refreshing at up to 120 times per second. By their very nature, any video material sent to a digital display must be converted to the display's native resolution. Further, digital displays are inherently progressive scan devices since it is possible for all pixels to be on at once.

LCD, DLP, and LCOS displays all use a white light source to derive their pictures. For DLP and LCOS, this is a powerful and specially designed light bulb. The white light source used in LCDs is either a special fluorescent lamp or an array of white light emitting diodes (LEDs). In LCD displays, the backlight shines through the liquid-crystal control grid, which turns light on or off depending on the picture. Almost all LCD displays exhibit some “light bleed” when pixels are turned off. This light leakage causes dark scenes to be brighter than they should be and can result in a loss of detail in shadowy areas of the picture. In DLP and LCOS displays there is no light bleed because the “off” pixel state actually reflects the light away from the optical path, typically resulting in pictures with superior blacks and shadow detail. An iris (similar to a camera shutter) or electronic backlight modulation can be used to control the amount of light outputted to the screen, either in a fixed (overall brightness) or dynamic manner used to enhance shadow details, depending on the scene.

### Deinterlacing

Deinterlacing is the digital process of converting an interlaced image into a progressive scan image. All material must be deinterlaced before being sent to a digital display device.

Because of the ubiquitous NTSC, PAL, and now ATSC broadcast standards, almost all movie and video material delivered to consumers is in an interlaced format. Movies on DVD are provided natively in 480i, and movies from Blu-ray are delivered in 1080i. As a consequence of this, all of this material must be deinterlaced when displayed on a modern digital television.

The central problem in deinterlacing comes from motion. Interlaced video is recorded at a rate of 60 fields per second. This means that the even and odd lines that make up any given frame are not recorded at the same time. If all objects in the frame are still, adding two adjacent fields together to create one progressive frame is permissible. However, using such a simple method when moving objects are present will result in jagged edges or “jaggies” in the moving object since lines from the two adjacent fields do not line up.

To deal with this issue, better deinterlacers will compare separate fields against one another to detect motion (field one vs. field two). In picture regions with significant movement, the system will interpolate (average) the two motional areas to create that part of the progressive frame. This process is commonly known as motion adaptive deinterlacing.

As discussed above, digital systems have a finite response time. This issue is exacerbated in digital video processing versus audio processing since so much more information is conveyed. To put this in perspective, CD quality audio requires a bit rate of 1.4 megabits per second (Mbps). DVD video requires a bit rate of 5 Mbps. Blu-ray disc high-quality video requires a bit rate of 54 Mbps. From audio to Blu-ray, this is an information flow rate difference of over 38 times. Consequently, video processors almost always have to buffer, i.e. store in memory, several frames worth of data, creating a significant processing throughput delay. This is where audio and video can easily get out of time and cause lip-sync problems.

Because deinterlacers have no prior knowledge of what the next field of video information will hold, they have to store and analyze, from scratch, each and every video field. There are many different motion detection systems in use. All of these algorithms are quite complex and take significant time to do their jobs.

With the method of this invention, the interlaced video stream can be analyzed offline before playback starts. The analysis engine 14 may be operated to create performance metadata containing information about field motion, formatted in such a way as to benefit deinterlacing. This information may allow the playback controller 24 to enable a real-time deinterlacer to work more efficiently by providing it with advance notice of where in the original media file moving objects will appear and what degree of analysis is required (full field or partial region) to encompass all the motion in a frame. The streaming metadata removes part of the processing burden from the real-time system and allows a predictive and/or search oriented task to become more decision oriented. The playback system 30 can now focus on determining how to best manipulate the data rather than gathering the data itself since part of that task has already been accomplished.

### Cadence or Rate Detection

Films are recorded at 24 frames per second. Interlaced video is expressed at 30 frames per second (60 fields/sec). When creating interlaced video content from, film material, a special interlacing method is required due to frame rate differences. As a result of this special “encoding” method, “3:2 pulldown” must be used during deinterlacing to properly convert the interlaced film material to progressive scan at 30 frames per second.

Because every film frame must be split into fields, the first frame is used to make three fields of video, and the next film frame is used to make the next two fields of video. This three-two sequence repeats in an ongoing fashion and adapts the two disparate frame rates. For deinterlacing, this is a problem because adjacent fields may have come from completely different frames. If two adjacent frames represent two completely different scenes (no data in common), averaging information from the two does no good.

As such, to accurately deinterlace film-based material, the video system must properly detect the 3:2 cadence in order to correctly reconstruct the progressive images at the alternate frame rate. In this manner, the hardware can distinguish which field corresponds with which original frame. Unfortunately, the sequence does not always occur continually due to anomalies cause by video editing. That means the video system must constantly redetect the frame rate to properly convert the material.

The analyzer engine 14 may be employed to encode metadata that may not only identify film-based material but may also mark video fields to indicate cadence. This may completely remove the need for cadence detection in a real-time deinterlacer and always make sure that the proper deinterlacing is being performed in a high quality fashion.

### Dynamic Backlight Control

As detailed above, LCD televisions and projectors suffer from light bleed through the LCD panel. Light leakage can cause black portions of an image to appear gray and can result in a loss of detail in shadowy areas of the picture. Some televisions and projectors offer dynamic iris control that modulates the iris size to effect the total amount of light shown on the screen. The iris will shrink for darker scenes to improve black levels and cut down on light leakage. Video must be analyzed in real-time on a frame-by-frame basis to determine the best level for the iris without introducing “flickering” artifacts.

Similarly, some LCD televisions with LED backlighting offer direct backlight modulation that changes the brightness of individual LEDs to maximize the contrast, e.g. difference between light and dark, within each frame itself. Careful, real-time, frame-by-frame analysis is required since no data is input to the playback system 30 regarding the content of upcoming frames. Easily recognized artifacts can be introduced if the backlight modulation is not smooth and carefully modulated.

As with motion detection, digital systems must perform frame analyses by buffering a number of frames in memory. This buffering will result in a processing throughput delay.

The analyzer engine 14 may be employed to encode metadata with performance parameters pertaining to scene brightness information that may prove invaluable for making appropriate backlight decisions. With knowledge of upcoming frame brightness, a modulation algorithm in the playback controller 24 may cause the video component(s) of the playback system 30 to respond in the smoothest, most visually pleasing fashion without undue processing delay.

### Edge Detection & Enhancement

Edge detection is necessary when it is desirable to enhance the apparent detail or sharpness in an image. A mathematical search algorithm must comb each individual frame to find the edges before any manipulation can commence.

The analyzer engine 14 may be employed to encode metadata containing a simplified edge map for each frame that would help remove part of the search and detection burden from the enhancement processing. It may also convey how the edges change from one frame to the next. It is contemplated that edge enhancement processing and/or detail enhancement processing would, as a result of using the metadata, work more quickly with potentially improved end results.

### Video Scaling

Because digital displays often have varying native resolutions and since film and television aspect ratios do not always match, some form of video scaling is often required to format the source material for the display device. Presently, the most well known type of scaling is “upconversion” of standard definition DVD material to 1080p for display on an HDTV. Besides mathematical scaling, other processing must be done as a part of the scaling system in order to maintain apparent details when effectively doubling the picture resolution.

As with other video processing techniques discussed above, the analyzer engine 14 may be employed to obtain metadata with the relevant performance parameter, i.e. in this case, motional changes. Input of such metadata to the playback controller 24 may help streamline the scaling process.

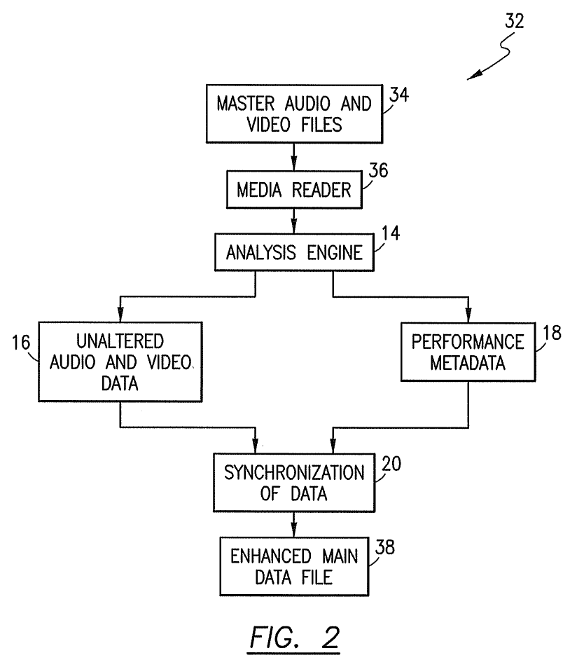

### Embodiments of FIGS. 2-5

Referring now to FIGS. 2-5, alternative implementations of the method of this invention are schematically illustrated. Many elements of the apparatus depicted in FIGS. 2-5 are common to that described in connection with a discussion of FIG. 1, and therefore the same reference numbers are used in such FIGS. to denote elements from FIG. 1. Further, except as noted below, elements of embodiments illustrated in FIGS. 2-5 function in the same manner as described with reference to FIG. 1.

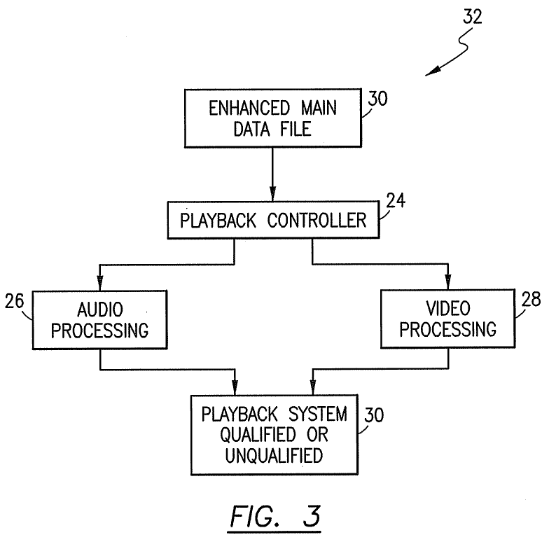

With reference initially to FIGS. 2 and 3, an apparatus 32 is shown which depicts an implementation of this invention wherein a recording studio, movie studio or other source of original media files produces the enhanced media file which may be sold to the consumer for playback. As schematically illustrated in FIG. 2, a master audio and video file, assuming, for purposes of discussion, that the original media file is a motion picture, is represented by box 34. The master file is input to a media reader 36, which, in turn, inputs the original media file to the analysis engine 14. The analysis engine 14 operates in the same manner described above in connection with a discussion of FIG. 1 to create an enhanced media file or main data file as depicted in box 38.

The elements shown in FIG. 3 are employed by the consumer at his or her home, or another location having a playback system 30. The enhanced media file or main data file 38 is input to the playback controller 24 which is effective to execute audio processing 26 and video processing 28 of the enhanced media file or main data file 38 prior to input to the playback system 30, using techniques described in detail above.

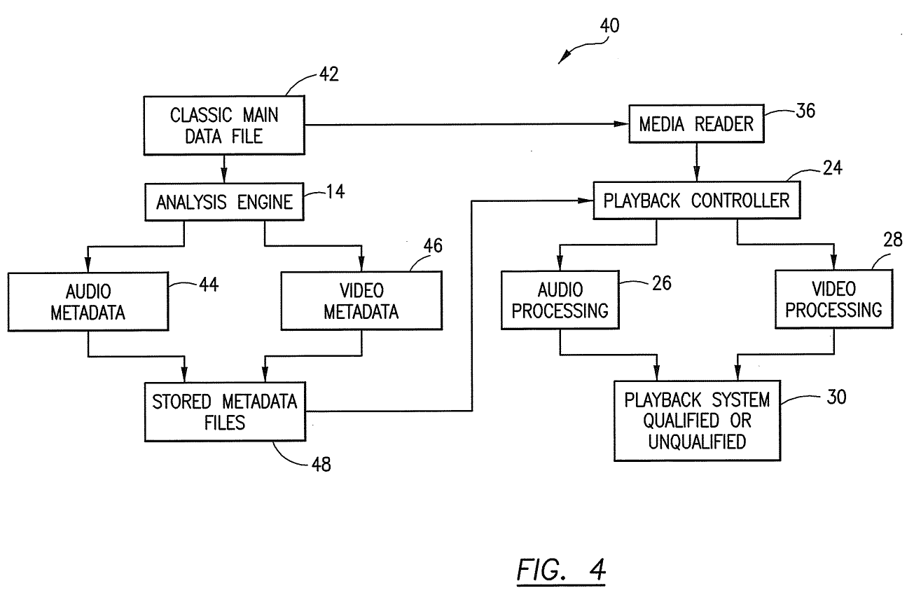

With reference to FIG. 4, another implementation of the method of this invention is illustrated. In this embodiment, an apparatus 40 is provided for accommodating “classic” main data or original media files 42 such as older movies. The file 42 is input to an analyzer engine 14 that produces a stream of audio metadata 44 and video metadata 46 which are stored as designated by box 48. It is contemplated that the stored file 48 may be created by a movie studio and bundled with a DVD as data on a thumb drive or other memory device, for example, or, alternatively, the stored file may be created on one's home system as discussed in FIG. 1. In either case, the stored file 48 is input to a playback controller 24 where it is stored on local memory. The main media or data file 42 is input to a media reader 36 of the type employed in the apparatus 32 of FIGS. 2 and 3, and from there to the playback controller 24. Synchronization of the audio and video metadata within the stored metadata file 48 and the main media or data file 42 is accomplished within the playback controller 24 in this embodiment, in the same manner as within the analyzer engine 14 described above, to create an enhanced media file which undergoes appropriate audio and video processing represented by boxes 26 and 28 prior to input to the playback system 30.

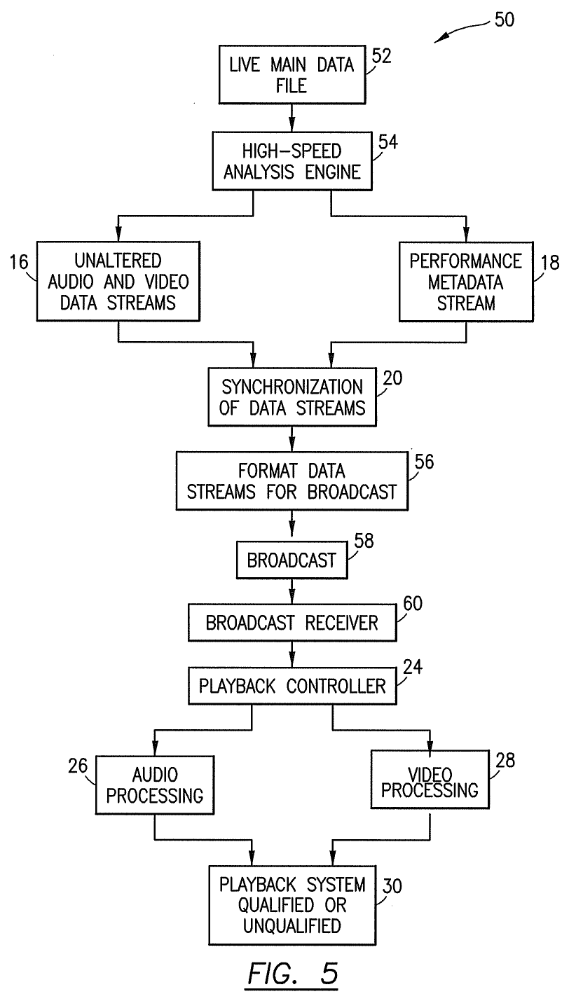

The apparatus 50 schematically shown in FIG. 5 is a still further implementation of the method of this invention except in the application of broadcast media instead of media recorded on a DVD, CD or the like as in the embodiments of FIGS. 1-4. A file identified as a live main data file at box 52 is representative of a television or other media broadcast. A “high-speed” analysis engine 54 produces real-time streams of unaltered audio and video data, depicted by box 16, and metadata as represented by box 18. The analysis engine 54 is functionally similar to the analysis engine 14 of FIG. 1 except with enhanced processing capability to operate at higher speeds. The data streams 16 and 18 are synchronized in the same manner as in FIG. 1, at box 20, to produce an enhanced media file which is then formatted for broadcast as represented by box 56. Once broadcast, as represented by box 58, the enhanced media file is received by a broadcast receiver 60 located at one's home, for example. The broadcast receiver 60 may be an off-air receiver, a cable box or a satellite box. The broadcast receiver 60 inputs the enhanced media file to the playback controller 24 which provides audio processing 26 and video processing 28 prior to input to the playback system 30. It is contemplated that live television broadcasts, for example, could undergo the analysis described above if transmitted on a suitable delay. Prerecorded media that is broadcast may be handled in essentially the same manner as described in connection with a discussion of FIG. 1.

While the invention has been described with reference to a preferred embodiment, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of media playback optimization, comprising:
(a) analyzing data contained in an original media file;
(b) generating performance parameters as a result of the analysis in step (a);
(c) encoding the performance parameters as metadata;
(d) synchronizing the data in the original media file with the metadata to create an enhanced media file;
(e) initiating at least one audio processing technique or at least one video processing technique in response to input of the enhanced media file to a playback controller; and
(f) inputting the enhanced media file following step (e) to a playback system.

2. The method of claim 1 in which step (b) comprises generating performance parameters relating to audio data contained in the media file.

3. The method of claim 2 in which step (b) comprises generating one or more performance parameters relating to audio bandwidth, audio crest factor, audio signal levels, frequency spectrum, time duration of peak audio signals or audio dynamic range.

4. The method of claim 1 in which step (b) comprises generating performance parameters relating to video data contained in the media file.

5. The method of claim 4 in which step (b) comprises generating one or more performance parameters relating to video brightness, video dynamic range, motion detection, cadence detection, edge detection or scaling.

6. The method of claim 1 in which step (e) comprises initiating at least one audio processing technique relating to adaptive equalization, level control, bandwidth enhancement, compression, limiting or dynamic range enhancement.

7. The method of claim 1 in which step (e) comprises initiating at least one video processing technique relating to deinterlacing, cadence, backlight control, detail enhancement, edge enhancement or video scaling.

8. The method of claim 1 in which step (d) comprises synchronizing audio data and video data in the original media file with the metadata to create an enhanced media file in which the metadata is streamed in advance of the audio data and the video data in the original media file.

9. The method of media playback optimization, comprising:
(a) providing an enhanced media file in which data contained in an original media file is synchronized with metadata encoded from performance parameters determined from an analysis of the original media file;
(b) initiating at least one audio processing technique or at least one video processing technique in response to input of the enhanced media file to a playback controller; and
(c) inputting the enhanced media file following step (b) to a playback system.

10. The method of claim 9 in which step (b) comprises initiating at least one audio processing technique relating to adaptive equalization, level control, bandwidth enhancement, compression, limiting or dynamic range enhancement.

11. The method of claim 9 in which step (b) comprises initiating at least one video processing technique relating to deinterlacing, cadence, backlight control, edge enhancement, detail enhancement or video scaling.

12. The method of claim 9 in which step (a) comprises providing an enhanced media file wherein the original media file is synchronized with the metadata such that the metadata is streamed in advance of audio data and video data contained in the original media file.

13. The method of creating an enhanced media file for optimizing playback, comprising:
(a) analyzing data contained in an original media file;
(b) generating performance parameters as a result of the analysis in step (a);
(c) encoding the performance parameters as metadata;
(d) synchronizing the audio data and the video data in the original media file with the metadata to create an enhanced media file in which the metadata is streamed in advance of the audio data and the video data in the original media file.

14. The method of claim 13 in which step (b) comprises generating performance parameters relating to audio data contained in the media file.

15. The method of claim 14 in which step (b) comprises generating one or more performance parameters relating to audio bandwidth, audio crest factor, audio signal levels, frequency spectrum, time duration of peak audio signals or audio dynamic range.

16. The method of claim 13 in which step (b) comprises generating performance parameters relating to video data contained in the media file.

17. The method of claim 16 in which step (b) comprises generating one or more performance parameters relating to video brightness, video dynamic range, motion detection, cadence detection, edge detection or scaling.

18. A method of media playback optimization, comprising:
(a) analyzing data contained in an original media file;
(b) generating performance parameters as a result of the analysis in step (a);
(c) encoding the performance parameters as metadata;
(d) synchronizing the data in the original media file with the metadata to create an enhanced media file;
(e) analyzing performance capabilities of the components of a playback system and assigning qualification designations to such components;
(f) initiating at least one audio processing technique or at least one video processing technique in response to input of the enhanced media file to a playback controller and in response to the input of the qualification designations assigned to the components of the playback system to the playback controller;
(g) inputting the enhanced media file following step (f) to the playback system.

19. The method of claim 18 in which step (b) comprises generating one or more performance parameters relating to audio bandwidth, audio crest factor, audio signal levels, frequency spectrum, time duration of peak audio signals or audio dynamic range.

20. The method of claim 18 in which step (b) comprises generating one or more performance parameters relating to video brightness, video dynamic range motion detection, cadence detection, edge detection or scaling.

21. The method of claim 18 in which step (e) comprises initiating at least one audio processing technique relating to adaptive equalization, level control, bandwidth enhancement, compression, limiting or dynamic range enhancement.

22. The method of claim 18 in which step (e) comprises initiating at least one video processing technique relating to deinterlacing, cadence, backlight control, edge enhancement, detail enhancement or video scaling.

23. The method of claim 18 in which step (d) comprises synchronizing audio data and video data in the original media file with the metadata to create an enhanced media file in which the metadata is streamed in advance of the audio data and the video data in the original media file.

24. The method of claim 18 in which step (f) includes inputting the qualification designations assigned to the components of the playback system manually to the playback controller.

25. The method of claim 18 in which step (f) includes inputting the qualification designations assigned to the components of the playback system automatically to the playback controller.

26. A method of media playback optimization, comprising:
(a) analyzing audio data and video data contained in an original broadcast media file;
(b) generating performance parameters as a result of the analysis in step (a);
(c) encoding the performance parameters as metadata;
(d) synchronizing the audio data and the video data in the original broadcast media file with the metadata to create an enhanced media file;
(e) broadcasting the enhanced media file to a broadcast receiver;
(f) initiating at least one audio processing technique or at least one video processing technique in response to input of the enhanced media file by the broadcast receiver to a playback controller; and
(g) inputting the enhanced media file following step (f) to a playback system.

27. The method of claim 26 in which step (b) comprises generating one or more performance parameters relating to audio bandwidth, audio crest factor, audio signal levels, frequency spectrum, time duration of peak audio signals or audio dynamic range.

28. The method of claim 26 in which step (b) comprises generating one or more performance parameters relating to video brightness, video dynamic range, motion detection, cadence detection, edge detection or scaling.

29. The method of claim 26 in which step (f) comprises initiating at least one audio processing technique relating to adaptive equalization, level control, bandwidth enhancement, compression, limiting or dynamic range enhancement.

30. The method of claim 26 in which step (f) comprises initiating at least one video processing technique relating to deinterlacing, cadence, backlight control, edge enhancement, detail enhancement or video scaling.

31. The method of claim 26 in which step (d) comprises synchronizing audio data and video data in the original media file with the metadata to create an enhanced media file in which the metadata is streamed in advance of the audio data and the video data in the original media file.

32. A method of media playback optimization, comprising:
(a) analyzing audio data and video data contained in an original media file;
(b) generating performance parameters as a result of the analysis in step (a);
(c) encoding the performance parameters as metadata, and creating a stored metadata file;
(d) synchronizing the original media file with the stored metadata file within a playback controller;
(e) initiating at least one audio processing technique or at least one video processing technique in response to input of the stored metadata file and the original media file to the playback controller; and
(e) inputting the original media file following step (e) to a playback system.

33. The method of claim 32 in which step (b) comprises generating one or more performance parameters relating to audio bandwidth, audio crest factor, audio signal levels, frequency spectrum, time duration of peak audio signals or audio dynamic range.

34. The method of claim 32 in which step (b) comprises generating one or more performance parameters relating to video brightness, video dynamic range, motion detection, cadence detection, edge detection or scaling.

35. The method of claim 32 in which step (e) comprises initiating at least one audio processing technique relating to adaptive equalization, level control, bandwidth enhancement, compression, limiting or dynamic range enhancement.

36. The method of claim 32 in which step (e) comprises initiating at least one video processing technique relating to deinterlacing, cadence, backlight control, edge enhancement, detail enhancement or video scaling.

37. The method of claim 32 in which step (d) comprises synchronizing audio data and video data in the original media file with the metadata to create an enhanced media file in which the metadata is streamed in advance of the audio data and the video data in the original media file.
